(19) United States
(12) Patent Application Publication
(10) Pub. No.: US 2011/0267991 A1
(43) Pub. Date: Nov. 3, 2011

(54) HARQ FEEDBACK FOR RELAY SYSTEMS

(75) Inventors: ALEKSANDAR DAMNJANOVIC, DEL MAR, CA (US); WANSHI CHEN, SAN DIEGO, CA (US); JUAN MONTOJO, SAN DIEGO, CA (US)

(73) Assignee: QUALCOMM INCORPORATED, San Diego, CA (US)

(21) Appl. No.: 13/099,155

(22) Filed: May 2, 2011

Related U.S. Application Data
(60) Provisional application No. 61/330,853, filed on May 3, 2010.

(51) Int. Cl. H04B 7/14; H04B 7/00

(52) U.S. Cl. 370/279; 370/277

(57) ABSTRACT

Certain aspects of the present disclosure provide techniques and apparatuses for acknowledging transmissions in a system utilizing a half-duplex node. According to certain aspects, a half-duplex node may receive, in a plurality of subframes, a plurality of downlink transmissions and send an uplink transmission comprising a plurality of bits indicative of whether the downlink transmissions were successfully received.

### CLAIM OF PRIORITY UNDER 35 U.S.C. §119

The present application for patent claims benefit of U.S. Provisional Patent Application Ser. No. 61/330,853, entitled, “HARQ FEEDBACK FOR LTE RELAYS,” filed May 3, 2010 and assigned to the assignee hereof and hereby expressly incorporated by reference herein.

### BACKGROUND

1. Field

Certain aspects of the disclosure relate generally to wireless communications systems and, more particularly, to techniques for acknowledging transmissions sent across multiple subframes.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out (SISO), multiple-in-single-out (MISO) or a multiple-in-multiple-out (MIMO) system.

To supplement conventional mobile phone network base stations, additional base stations may be deployed to provide more robust wireless coverage to mobile units. For example, wireless relay stations and small-coverage base stations (e.g., commonly referred to as access point base stations, Home Node Bs, femto access points, or femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

### SUMMARY

Certain aspects of the present disclosure provide a method for wireless communication by a half-duplex node. The method generally includes receiving, in a plurality of subframes, a plurality of downlink transmissions and sending an uplink transmission comprising a plurality of bits indicative of whether the downlink transmissions were successfully received.

Certain aspects of the present disclosure provide an apparatus for wireless communication by a half-duplex node. The apparatus generally includes means for receiving, in a plurality of subframes, a plurality of downlink transmissions and means for sending an uplink transmission comprising a plurality of bits indicative of whether the downlink transmissions were successfully received.

Certain aspects of the present disclosure provide an apparatus for wireless communication by a half-duplex node. The apparatus generally includes at least one processor and a memory coupled to the at least one processor. The at least one processor is generally configured to receive, in a plurality of subframes, a plurality of downlink transmissions and send an uplink transmission comprising a plurality of bits indicative of whether the downlink transmissions were successfully received.

Certain aspects of the present disclosure provide a computer-program product for wireless communication by a half-duplex node. The computer-program product generally includes a computer-readable medium comprising code for receiving, in a plurality of subframes, a plurality of downlink transmissions and sending an uplink transmission comprising a plurality of bits indicative of whether the downlink transmissions were successfully received.

Certain aspects of the present disclosure provide a method for wireless communication with a half-duplex node. The method generally includes transmitting, in a plurality of subframes, a plurality of downlink transmissions to the half-duplex node and receiving, from the half-duplex node, an uplink transmission comprising a plurality of bits indicative of whether the downlink transmissions were successfully received.

Certain aspects of the present disclosure provide an apparatus for wireless communication with a half-duplex node. The apparatus generally includes means for transmitting, in a plurality of subframes, a plurality of downlink transmissions to the half-duplex node and means for receiving, from the half-duplex node, an uplink transmission comprising a plurality of bits indicative of whether the downlink transmissions were successfully received.

Certain aspects of the present disclosure provide an apparatus for wireless communication with a half-duplex node. The apparatus generally includes at least one processor and a memory coupled to the at least one processor. The at least one processor is generally configured to transmit, in a plurality of subframes, a plurality of downlink transmissions to the half-duplex node and receive, from the half-duplex node, an uplink transmission comprising a plurality of bits indicative of whether the downlink transmissions were successfully received.

Certain aspects of the present disclosure provide a computer-program product for wireless communication with a half-duplex node. The computer-program product generally includes a computer-readable medium comprising code for transmitting, in a plurality of subframes, a plurality of downlink transmissions to the half-duplex node and receiving, from the half-duplex node, an uplink transmission comprising a plurality of bits indicative of whether the downlink transmissions were successfully received.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in which certain aspects of the present disclosure may be utilized.

FIG. 2 is a block diagram of a wireless communication system, in which certain aspects of the present disclosure may be utilized.

FIG. 3 illustrates an example frame structure in a wireless communications network in accordance with certain aspects of the present disclosure.

FIG. 4 illustrates an exemplary wireless communication system having a relay, in which certain aspects of the present disclosure may be utilized.

FIG. 5 is a block diagram illustrating example modules of a wireless communication system with apparatus capable of implementing certain aspects of the present disclosure.

FIG. 6 illustrates an example uplink/downlink subframe configuration with which certain aspects of the present disclosure may be applied.

FIGS. 7 and 8 illustrate example operations that may be performed by a relay node and donor base station, respectively, in accordance with aspects of the present disclosure.

FIGS. 9 and 10 illustrate example operations that may be performed by a user equipment and relay node, respectively, in accordance with aspects of the present disclosure.

### DETAILED DESCRIPTION

Relaying has been considered for wireless systems, such as LTE-Advanced, as a tool to improve coverage of high data rates, group mobility, temporary network deployment, and the cell-edge throughput and/or to provide coverage in new areas. The A relay node may be wirelessly connected to a radio-access network via a donor base station to provide serves to wireless terminals, or user equipment (UE).

Certain aspects of the present disclosure provide apparatuses and techniques for a relay node to acknowledge, in a single uplink transmission, whether downlink transmissions sent from a donor base station over a plurality of subframes were successfully received.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

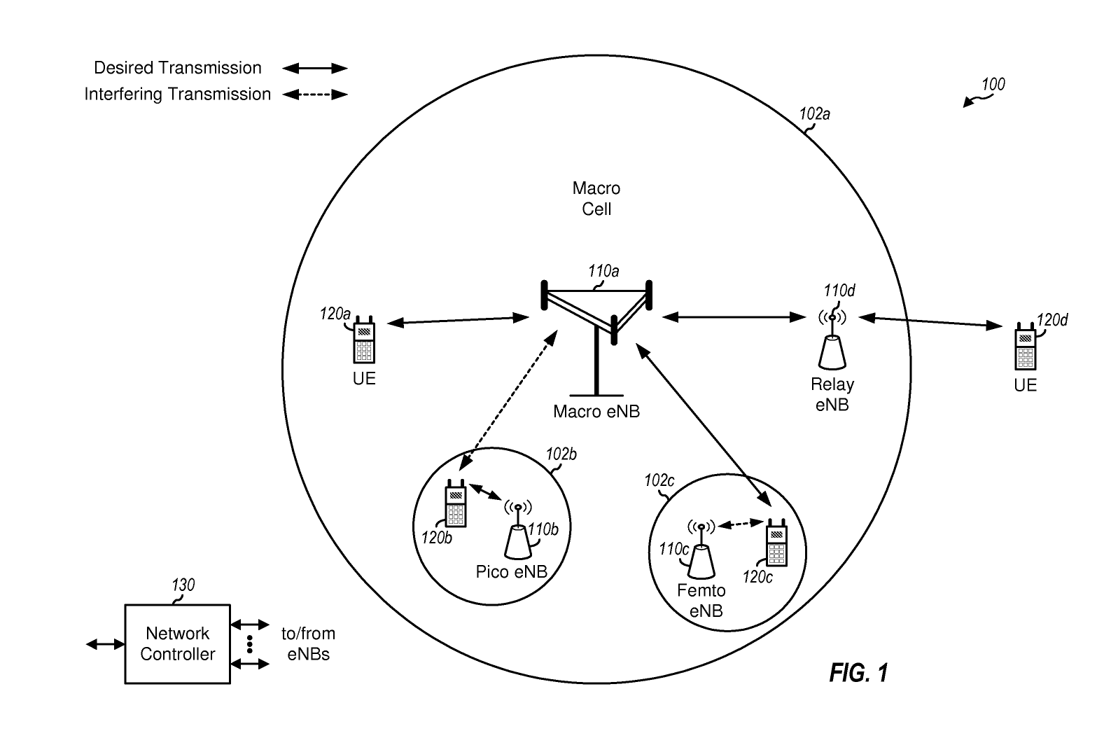

FIG. 1 shows a wireless communication network 100 in which RA procedures described herein may be performed. The network 100 may be an LTE network or some other wireless network. Wireless network 100 may include a number of evolved Node Bs (eNBs) 110 and other network entities. An eNB is an entity that communicates with UEs and may also be referred to as a base station, a Node B, an access point, etc. Each eNB may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG)). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, an eNB 110a may be a macro eNB for a macro cell 102a, an eNB 110b may be a pico eNB for a pico cell 102b, and an eNB 110c may be a femto eNB for a femto cell 102c. An eNB may support one or multiple (e.g., three) cells. The terms “eNB”, “base station” and “cell” may be used interchangeably herein.

Wireless network 100 may also include relay stations. A relay station is an entity that can receive a transmission of data from an upstream station (e.g., an eNB or a UE) and send a transmission of the data to a downstream station (e.g., a UE or an eNB). A relay station may also be a UE that can relay transmissions for other UEs. In the example shown in FIG. 1, a relay station 110d may communicate with macro eNB 110a and a UE 120d in order to facilitate communication between eNB 110a and UE 120d. A relay station may also be referred to as a relay eNB, a relay base station, a relay, etc.

Wireless network 100 may be a heterogeneous network that includes eNBs of different types, e.g., macro eNBs, pico eNBs, femto eNBs, relay eNBs, etc. These different types of eNBs may have different transmit power levels, different coverage areas, and different impact on interference in wireless network 100. For example, macro eNBs may have a high transmit power level (e.g., 5 to 40 Watts) whereas pico eNBs, femto eNBs, and relay eNBs may have lower transmit power levels (e.g., 0.1 to 2 Watts).

A network controller 130 may couple to a set of eNBs and may provide coordination and control for these eNBs. Network controller 130 may communicate with the eNBs via a backhaul. The eNBs may also communicate with one another, e.g., directly or indirectly via a wireless or wireline backhaul.

As will be described in greater detail below, according to certain aspects, eNBs may perform inter-cell interference coordination (ICIC). ICIC may involve negotiation between eNBs to achieve resource coordination/partitioning to allocate resources to an eNB located near the vicinity of a strong interfering eNB. The interfering eNB may avoid transmitting on the allocated/protected resources, possibly except for a CRS. A UE can then communicate with the eNB on the protected resources in the presence of the interfering eNB and may observe no interference (possibly except for the CRS) from the interfering eNB

UEs 120 may be dispersed throughout wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc.

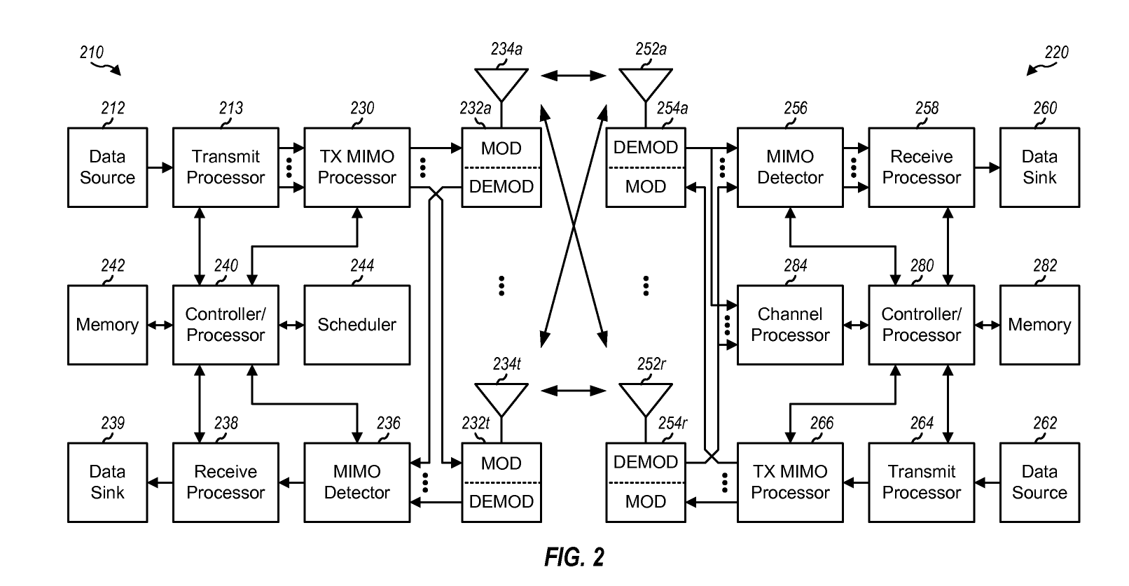

FIG. 2 shows a block diagram of a design of base station/eNB 210 and a receiving system 220 (e.g., a UE or relay node), which may be one of the base stations/eNBs and one of the UEs in FIG. 1. Base station 210 may be equipped with T antennas 234a through 234t, and receiving system 220 may be equipped with R antennas 252a through 252r, where in general T≧1 and R≧1.

At base station 210, a transmit processor 213 may receive data from a data source 212 for one or more UEs, select one or more modulation and coding schemes (MCS) for each UE based on CQIs received from the UE, process (e.g., encode and modulate) the data for each UE based on the MCS(s) selected for the UE, and provide data symbols for all UEs. Transmit processor 213 may also process system information (e.g., for SRPI, etc.) and control information (e.g., CQI requests, grants, upper layer signaling, etc.) and provide overhead symbols and control symbols. Processor 213 may also generate reference symbols for reference signals (e.g., the CRS) and synchronization signals (e.g., the PSS and SSS). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At receiving system 220, antennas 252a through 252r may receive the downlink signals from base station 210 and/or other base stations and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for receiving system 220 to a data sink 260, and provide decoded control information and system information to a controller/processor 280. A channel processor 284 may determine RSRP, RSSI, RSRQ, CQI, etc., as described below.

On the uplink, at receiving system 220, a transmit processor 264 may receive and process data from a data source 262 and control information (e.g., for reports comprising RSRP, RSSI, RSRQ, CQI, etc.) from controller/processor 280. Processor 264 may also generate reference symbols for one or more reference signals. The symbols from transmit processor 264 may be precoded by a TX MIMO processor 266 if applicable, further processed by modulators 254a through 254r (e.g., for SC-FDM, OFDM, etc.), and transmitted to base station 210. At base station 210, the uplink signals from receiving system 220 and other UEs may be received by antennas 234, processed by demodulators 232, detected by a MIMO detector 236 if applicable, and further processed by a receive processor 238 to obtain decoded data and control information sent by receiving system 220. Processor 238 may provide the decoded data to a data sink 239 and the decoded control information to controller/processor 240.

Controllers/processors 240 and 280 may direct the operation at base station 210 and receiving system 220, respectively. Processor 240 and/or other processors and modules at base station 210 may perform or direct operations for configuring the receiver system 220 in various manners. Memories 242 and 282 may store data and program codes for base station 210 and receiving system 220, respectively. A scheduler 244 may schedule UEs for data transmission on the downlink and/or uplink.

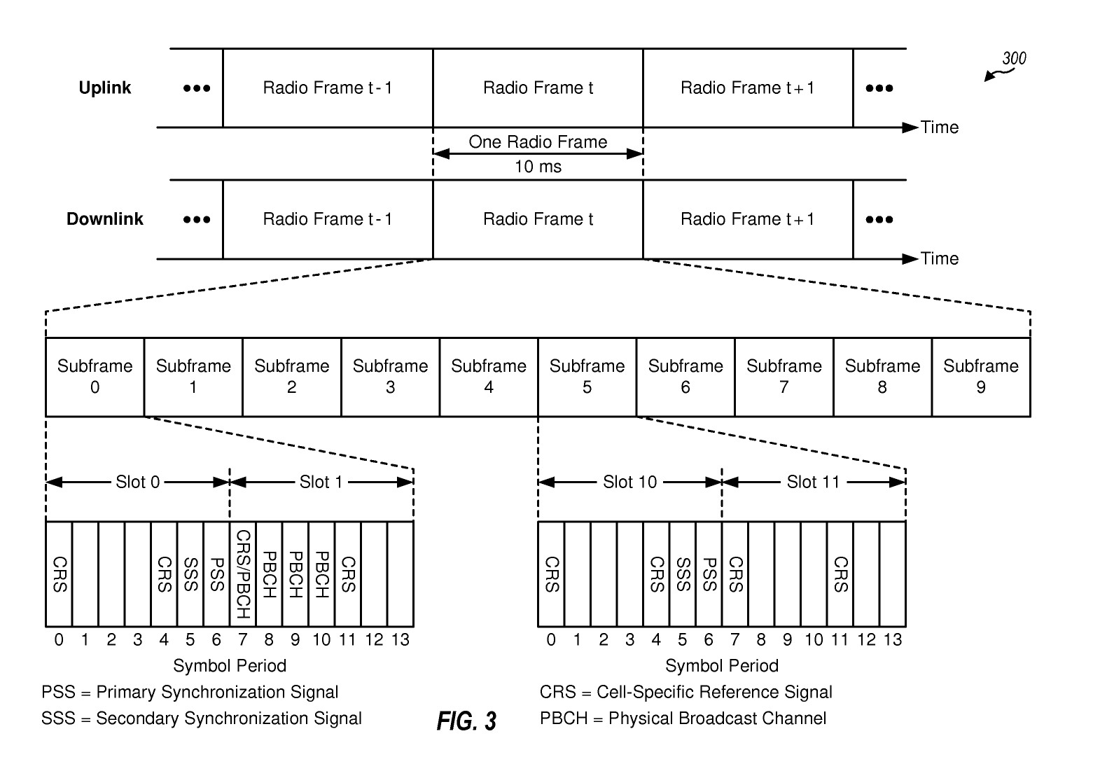

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 2) or six symbol periods for an extended cyclic prefix. The 2L symbol periods in each subframe may be assigned indices of 0 through 2L−1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

As described above, wireless communication systems may comprise a relay node associated with a donor base station to provide service to user equipments (UEs). As described above, the relay node may be connected to a radio-access network via the donor base station. The relay node may be used to supplement and extend coverage in a given geographical area by providing service to a plurality of UEs through the donor base station.

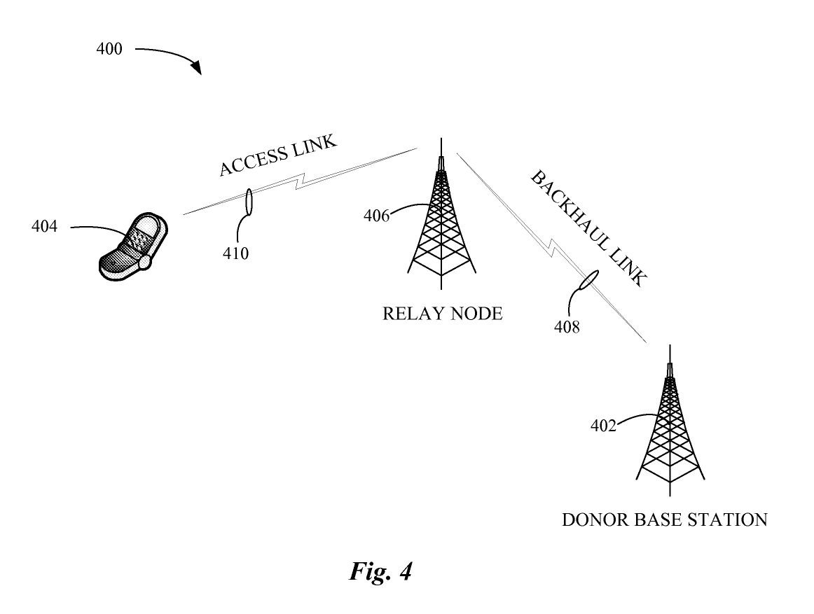

FIG. 4 illustrates an example wireless system 400 in which certain aspects of the present disclosure may be practiced. As illustrated, the system 400 includes a donor base station 402 (also known as a donor cell, a donor access point (AP), a donor BS, a donor eNodeB, or DeNB) that communicates with a UE 404 via a relay node 406 (also known as relay access point, relay base station, or ReNB). The relay node 406 may communicate with the donor BS 402 via a backhaul link 408 and with the UE 404 via an access link 410. In other words, the relay node 306 may receive downlink messages from the donor BS 402 over the backhaul link 408 and relay these messages to the UE 404 over the access link 410. Similarly, the relay node 406 may receive uplink messages from the UE 404 over the access link 410 and relay these messages to the donor BS 402 over the backhaul link 408.

According to certain aspects, the backhaul link 408 may be an “inband” connection, in which a network-to-relay link, such as the backhaul link 408, shares a same band with direct network-to-UE links within a donor cell defined by the donor base station. LTE Rel-8-compatible UEs may be able to connect to the donor in this case. According to certain aspects, the backhaul link may be an “outband” connection, in which a network-to-relay link may not operate in the same band as direct-to-UE links within the donor cell.

According to certain aspects, the relay node 406 may be a “Type 1” relay node compatible with LTE-Advanced. A Type 1 relay node is an inband relaying node generally characterized with the following features: A Type 1 relay node controls cells, each of each appears to a UE as a separate cell distinct from the donor cell. The cells may have their own Physical Cell ID (as defined in LTE Rel-8) and the relay node may transmit its own synchronization channels, reference symbols, and other control information. In the context of a single-cell operation, a UE may receive scheduling information and Hybrid Automatic Repeat Request (HARQ) feedback directly from the relay node, and the UE may send its control channels (e.g., SR, CQI, ACK) to the relay node. To Rel-8 UEs, a Type 1 relay node may appear as a Rel-8 eNodeB (i.e., the Type 1 relay node may be backwards compatible.) To LTE-Advanced-compatible UEs, a Type 1 relay node may appear differently than a Rel-8 eNodeB to enable and allow for further performance enhancements.

According to certain aspects, for inband relaying, the backhaul link 408 (i.e., the eNodeB-to-relay link) may operate in the same frequency as the access link 410 (i.e., the relay-to-UE link). Due to the fact that relay's transmitter may cause interference with the relay's own receiver, simultaneous eNodeB-to-relay and relay-to-UE transmissions on the same frequency resources may not be feasible. For example, the relay node 406 may have difficulty receiving a control channel from the donor base station 402 during a conventional PDCCH period because the relay node 406 may have to transmit its own reference signals to the UEs 404 during this time. As such, in order to allow inband backhauling of relay traffic on the backhaul link 408, some resources in the time-frequency domain may be set aside for the backhaul link 408 and may not be used for the access link 410 on the respective relay node 406. According to certain aspects, the relay node 406 may be configured for half-duplex operation, as described below, such that a control channel for the backhaul link 408 may be received by the relay node 406 in a time-frequency domain reserved for downlink data transmission from the donor base station 402 to the relay node 406.

According to certain aspects, the relay node 406 may be configured according to general principles of resource partitioning for half-duplex operation. Firstly, downlink backhaul and downlink access links (i.e., eNodeB-to-relay and relay-to-UE) may be time division multiplexed in a single frequency band. In other words, only one of the downlink backhaul and downlink access links may be any time. Secondly, uplink backhaul and uplink access links (i.e., relay-to-eNodeB and UE-to-relay) are also time division multiplexed in a single frequency band. In other words, only one of uplink backhaul and uplink access may be active at any time.

Transmission of downlink and uplink backhaul may be transmitted utilizing radio resources according to certain aspects described herein. For example, at the relay node, a boundary of an access link downlink subframe may be aligned with a boundary of a backhaul link downlink subframe, notwithstanding possible adjustment allowing for relay node transmit and/or receive switching. According to certain aspects, the set of downlink backhaul subframes, during which downlink backhaul transmission may occur, may be semi-statically assigned. The set of uplink backhaul subframes, during which uplink backhaul transmission may occur, may also be semi-statically assigned, or may be implicitly derived from the downlink backhaul subframes using the HARQ timing relationship.

According to certain aspects, a physical control channel (herein referred to as Relay Physical Downlink Control Channel, or “R-PDCCH”) may be used to dynamically or “semi-persistently” assign resources, within the semi-statically assigned subframes, for downlink backhaul data (corresponding to a physical channel such as a Relay Physical Downlink Shared Channel, or “R-PDSCH”). According to certain aspects, the R-PDCCH may assign downlink resources in the same and/or in one or more later subframes. According to certain aspects, the R-PDCCH may also be used to dynamically or “semi-persistently” assign resources for uplink backhaul data (corresponding to a physical channel such as a Relay Physical Uplink Shared Channel, “R-PDSCH”). According to certain aspects, the R-PDCCH may assign uplink resources in one or more later subframes.

According to certain aspects, within physical resource blocks (PRBs) semi-statically assigned for R-PDCCH transmission, a subset of the resources may be used for each R-PDCCH. The actual overall set of resources used for R-PDCCH transmission within the above mentioned semi-statically assigned PRBs may vary dynamically between subframes. These resources may correspond to the full set of OFDM symbols available for the backhaul link or be constrained to a subset of these OFDM symbols. The resources that are not used for R-PDCCH within the above-mentioned semi-statically assigned PRBs may be used to carry R-PDSCH or PDSCH. According to certain aspects, the R-PDCCH may be transmitted starting from an OFDM symbol within a subframe that is late enough such that a relay may receive it. R-PDSCH and R-PDCCH may be transmitted within the same PRBs or within separate PRBs as described further below.

According to certain aspects, the detailed R-PDCCH transmitter processing (i.e., channel coding, interleaving, multiplexing, etc.) may re-use LTE Rel-8 functionality to the extent possible, but may allow for the removal of certain unnecessary procedures or bandwidth-occupying procedures by considering the properties of the relay node. According to certain aspects, a “search space” approach for the backhaul link may be adapted from LTE Rel-8, utilizing a common search space that can be semi-statically configured (and may potentially include an entire system bandwidth). Additionally, a relay-node specific search space may be configured that is implicitly or explicitly known by the relay node.

### HARQ Feedback for Relay Systems

According to one aspect, over a donor eNodeB to relay node (backhaul) link or a relay node to UE (access) link, DL subframes may be semi-statically configured independently of UL subframes. Mapping may be specified that determines UL subframes that carry UL ACK/NACK for corresponding DL subframes. Mapping may be further specified that determines DL subframes that carry UL grants for corresponding UL subframes. It may be possible to configure asymmetric mapping, i.e., configure more DL subframes than UL subframes, or vice versa.

In a case of an asymmetric configuration for DL and UL backhaul subframes (i.e., subframes on a donor eNodeB to RN backhaul link or a RN to UE access link), it may be possible, or even desirable, to configure a many-to-one relationship where there are more DL subframes than UL subframes. In such a case, UL HARQ feedback may be required to acknowledge multiple transmissions.

Therefore, certain aspects of the present disclosure provide apparatuses and techniques for a relay node to acknowledge, in a single uplink backhaul transmission, whether downlink backhaul transmissions sent from a donor base station over a plurality of subframes were successfully received. While certain examples will be described with reference to backhaul connection between a donor base station and a relay node, the techniques presented herein may also be extended to the access link. In other words, a UE may acknowledge, in a single uplink transmission on the access link, whether downlink transmissions sent from a relay node over a plurality of subframes were successfully received.

This is in contrast to a UE directly served by a donor base station when the base station employs a frequency division duplex (FDD) system, where a same number of downlink subframes and uplink subframes are available. There is a one-to-one downlink to uplink subframe mapping. As a result, the donor base station needs to handle different UL HARQ feedback from the relay node and the UE directly served by the donor base station.

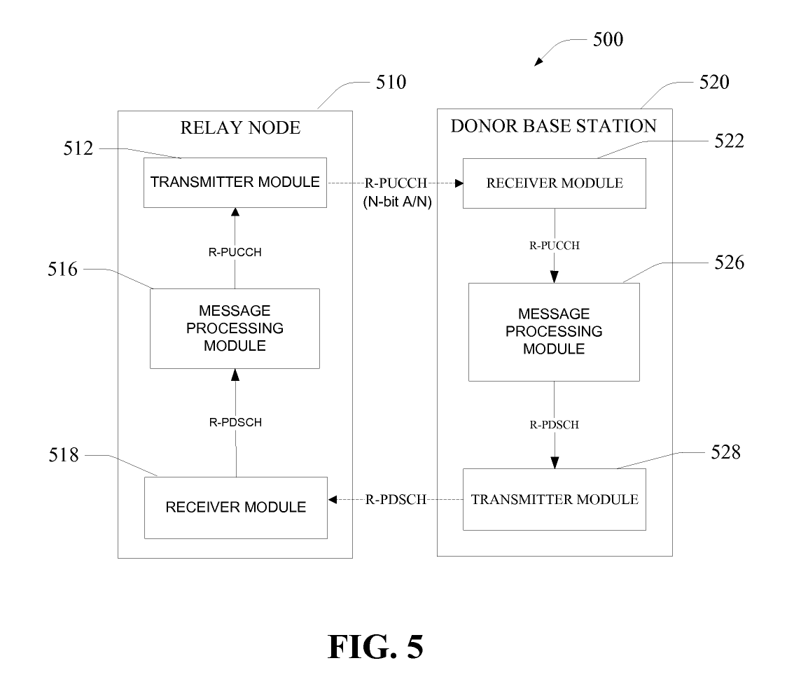

FIG. 5 illustrates an example wireless system 500 with components capable for performing operations described herein. As illustrated, the wireless system 500 includes a relay node 510 and a donor base station 520. While not illustrated, the relay node 510 may allow the base station 520 to communicate with a plurality of UEs.

According to certain aspects, the donor base station 520 may include a message processing module 524 configured to generate control and data messages to be transmitted to the relay node 510. As described above, these messages may carry information to be forwarded, by the relay node 510, to one or more UEs.

As illustrated, the message processing module may generate one or more physical downlink shared channel (PDSCH) messages to be transmitted to the relay node (labeled as a relay PDSCH or “R-PDSCH”), via a transmitter module 528. In some cases, the donor base station 520 may transmit the multiple R-PDSCH messages may be transmitted over multiple subframes using one or more component carriers.

According to certain aspects, the R-PDSCH messages may carry data or control information to be relayed to at least a UE. According to certain aspects, the relay node may receive a plurality of Physical Downlink Shared Channel (PDSCH) or Physical Downlink Control Channel (PDCCH) transmissions to be relayed to at least a UE. According to one aspect, the relay node may receive uplink grant information to be relayed to the UE.

As illustrated, the relay node 510 receives the R-PDSCH messages via a receiver module 518. The R-PDSCH messages may be provided to a message processing module 516. The R-PDSCH messages may be sent with Hybrid Automatic Repeat reQuest processes. Therefore, the relay node may need to acknowledge successful receipt or requests retransmission of packets which are detected to be erroneous. According to certain aspects, the message processing module 516 may monitor the reception of the R-PDSCH messages and generate a message with a plurality of bits to acknowledge whether a plurality of downlink transmissions received over a plurality of subframes were successfully received.

According to certain aspects, the message processing module 516 may generate an N-bit Ack/Nack (A/N) sequence that forms a code representing one of a plurality of possible combinations of downlink transmission successfully and unsuccessfully received by the relay node.

According to certain aspects, these N bits may be transmitted to the donor node B 510, via a transmitter module 512, in a physical uplink control channel (PUCCH) message or relay PUCCH (R-PUCCH). The PUCCH message may have any suitable format to carry the N A/N bits. For example, the PUCCH message may have a format similar to PUCCH format 2 defined in LTE Release 8 (and the A/N bits may be transmitted with channel status information). As another example, the PUCCH message may be transmitted in a PUCCH message with a new format.

According to certain aspects, the N of bits is determined based on the set of downlink subframes and the set of uplink subframes configured between the donor base station and the relay node. According to certain aspects, the N bits is further determined based on a downlink H-ARQ timing. As an example, the timing between any PDSCH transmission and an ACK/NAK transmission is at least 4 ms. As an example, the H-ARQ timing is chosen such that the ACK/NAK payloads across different uplink subframes are substantially uniform. According to certain aspects, the set of downlink subframes and uplink subframes have a periodicity of 8 ms and are configured on a semi-static basis.

In any case, the donor BS 520 may receive the PUCCH, via a receiver module 522, and the message processing module 526 may extract the bits therefrom to determine which downlink transmissions were successfully received.

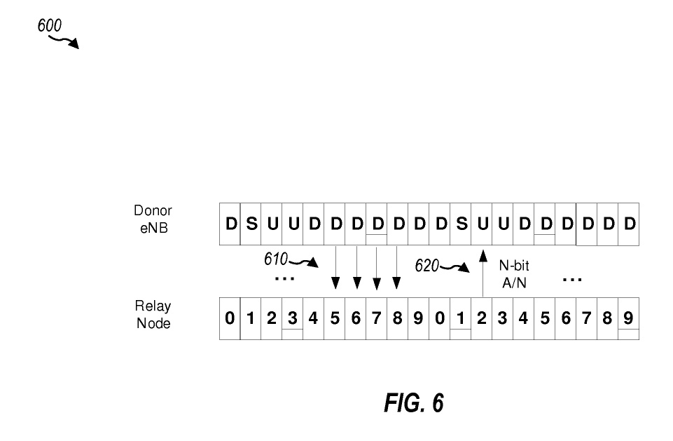

FIG. 6 illustrates how a relay node may acknowledge receipt of multiple downlink subframe transmissions with a single uplink transmission. As illustrated, the donor base station may send multiple downlink transmissions 610 to the relay node in multiple downlink subframes. The relay node may receive and process the downlink transmissions and send an uplink transmission 620 (e.g., a PUCCH) with multiple A/N bits providing an indication of whether (or which of) the downlink transmissions were successfully received.

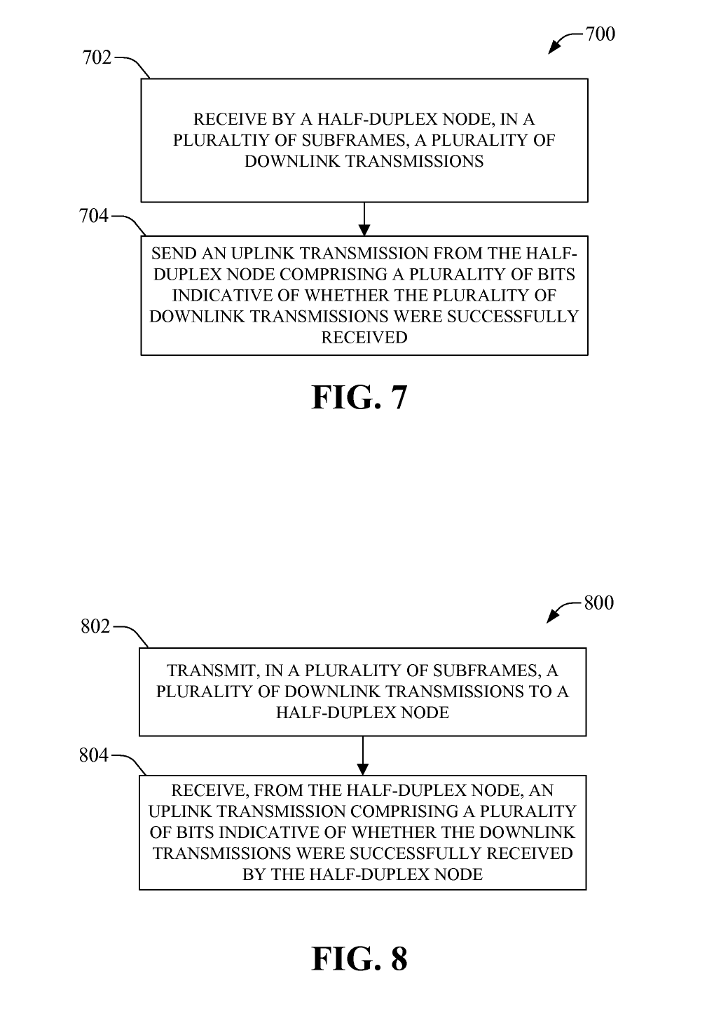

FIG. 7 illustrates exemplary operations 700 that may be performed by a half-duplex node in accordance with aspects of the present disclosure. For example, the operations may be performed by a relay node to acknowledge downlink subframes transmitted from a donor base station or by a UE to acknowledge downlink subframes from a relay node.

At 702, the half-duplex node may receive, in a plurality of subframes, a plurality of downlink transmissions from a donor base station. In one aspect, the half-duplex node may be relay node that receives a plurality of DL subframes to be relayed to a UE. According to certain aspects, the relay node may receive a plurality of Physical Downlink Shared Channel (PDSCH) or Physical Downlink Control Channel (PDCCH) transmissions. According to certain aspects, the relay node may receive uplink grant information to be relayed to the UE. According to certain aspects, the relay node may further determine whether each of the plurality of downlink transmissions was successfully received using any suitable means, such as, for example, error detection information received with the downlink transmissions.

At 704, the half-duplex node may send an uplink transmission comprising a plurality of bits indicative of whether the downlink transmissions were successfully received. According to certain aspects, the plurality of bits may also indicative of whether the grant information was successfully received. According to certain aspects, the plurality of bits may be sent in a Physical Uplink Control Channel (PUCCH) format 2 message, a PUCCH message of a similar format as format 2, or a ne PUCCH message format.

FIG. 8 illustrates exemplary operations 800 that may be performed by a device in communication with a half-duplex node, in accordance with aspects of the present disclosure. For example, the operations may be performed by a donor base station in communication with a half-duplex relay node or by a relay node in communication with a UE.

At 802, in a plurality of subframes, a plurality of downlink transmissions are transmitted to the half-duplex node. At 804, an uplink transmission, from the half-duplex node is received, the uplink transmission comprising a plurality of bits indicative of whether the downlink transmissions were successfully received.

According to certain aspects, the relay node may generate a HARQ message based on the mapping using a PUCCH message. According to one aspect, a format, such as PUCCH format 2 or some other new format, may be used to convey more bits for HARQ feedback. For example, Table 1, below illustrates example PUCCH formats and how a PUCCH message based on an existing PUCCH format 2 may carry

TABLE 1

| | Number of bits | Type of control |
|---|---|---|
| PUCCH format | per subframe, | information |
| 1a | 1 | HARQ ACK (1-bit) |
| 2 | 20 | Channel status reports |
| New (based on | 20 + N | Channel status reports |
| format 2) | | and HARQ-ACK for |
| | | multiple DL |
| | | transmissions (N-bits) |
| New (based on | >=N | HARQ-ACK for multiple |
| New format) | | DL transmissions (N- |
| | | bits) and optional Info |

channel status information and N HARQ-ACK bits. A new format may include N HARQ-ACK bits, as well as some optional information.

According to certain aspects, the plurality of A/N bits may comprise N bits that form a code indicative of one of the possible combinations of downlink transmission successfully and unsuccessfully received by the relay node. The particular number of bits utilized may depend on how many codewords are transmitted in a DL subframe and a type of diversity (or number of layers or spatial streams).

As a specific, but not limiting, example, according to certain aspects, ten bits may be used to send HARQ feedback for multiple transmissions using format 2. Assuming that independent HARQ feedback is sent for two codewords and DTX, five levels may be required per DL transmission. For a single DL subframe, a conventional PUCCH format 1 message may be utilized. For two DL subframes, a PUCCH format 1 type message may be employed, with a spreading factor reduction to two or five bits may be included in a PUCCH message of format 2.

Continuing with the example above, with 2 codewords and 5 levels, this may suggest that there are twenty-five possible combinations of successfully/unsuccessfully received DL transmissions (e.g., 5×5 for the different possible combinations assuming 2 codewords and 5 levels. Twenty-five possible combinations could mean 5 bits would be sufficient. On the other hand, for three DL subframes, seven bits (i.e., 5×5×5=125) may be utilized, while for four DL subframes, 10 bits (i.e., 5×5×5×5=625) may be utilized. These particular configurations are examples only, and a particular number of bits utilized may depend on particular design goals of a particular implementation.

According to certain aspects, the relay node may receive the downlink transmissions over a plurality of carriers. According to one aspect, a system employing a multicarrier backhaul link may be employed wherein a multitude of DL carriers supported by a single PUCCH. In one aspect, a PUCCH may carry UL ACK/NACK for multiple DL carriers and multiple subframes. According to one aspect, a new format may be employed, wherein HARQ feedback is conveyed for multiple carriers and multiple subframes. In order to reduce feedback size and support a large number of DL carriers, bundling may be configured where a single acknowledgement is sent for multiple DL carriers and/or codewords. For example, downlink transmissions sent in a common subframe on multiple carriers may be bundled with a single ACK.

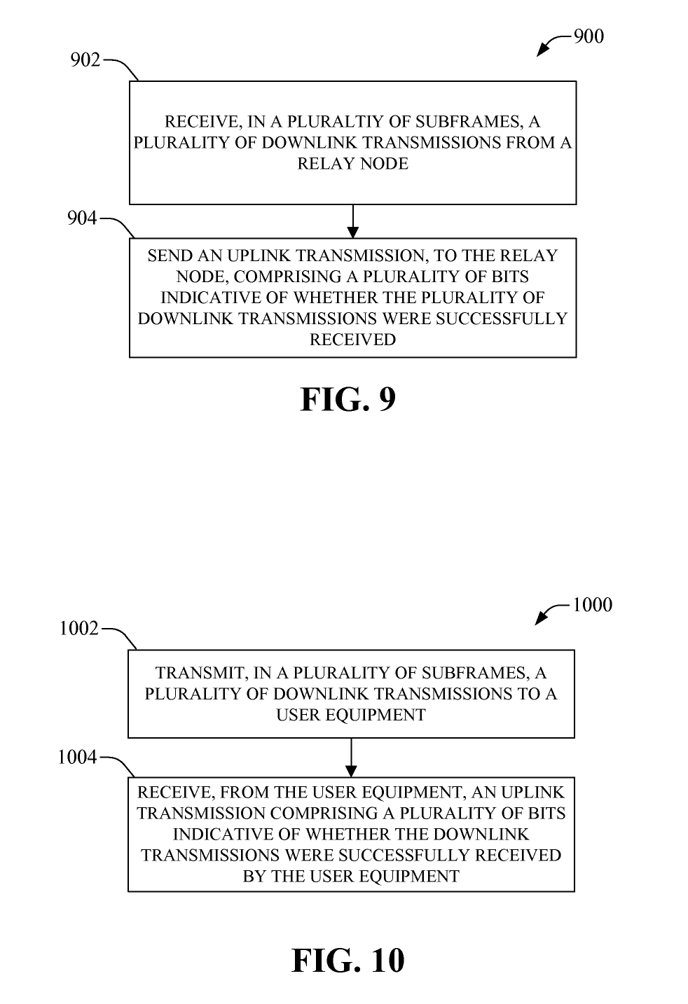

As noted above, the techniques described herein may also be utilized in an access link between a relay node and a UE. FIG. 9 illustrates exemplary operations 900 that may be performed by an UE. At 902, the UE may receive, in a plurality of subframes, a plurality of downlink transmissions from a relay node. At 904, the UE may send an uplink transmission, to the relay node, comprising a plurality of bits indicative of whether the downlink transmissions were successfully received.

FIG. 10 illustrates exemplary operations 1000 that may be performed by a relay node in accordance with aspects of the present disclosure. At 1002, the relay node may transmit, in a plurality of subframes, a plurality of downlink transmissions to a UE. At 1004, the relay node may receive an uplink transmission, from the UE, comprising a plurality of bits indicative of whether the downlink transmissions were successfully received

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for transmitting may comprise a transmitter, such as the transmitter unit 254 of the receiver system 220 (e.g., the UE or relay node) depicted in FIG. 2 or the transmitter unit 232 of the base station 210 shown in FIG. 2. Means for receiving may comprise a receiver, such as the receiver unit 254 of the receiver system 220 depicted in FIG. 2 or the receiver unit 232 of the transmitter system 210 shown in FIG. 2. Means for determining and/or means for performing may comprise a processing system, which may include one or more processors, such as the processor 280 and RX data processor 258 of the receiver system 220 or the processor 230 of the transmitter system 210 illustrated in FIG. 2. These means may also comprise any suitable combination of the transmitter modules 512, 528, the receiver modules 518, 522, and the message processor modules 516, 526 of FIG. 5.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method for wireless communication by a half-duplex node, comprising:
receiving, in a plurality of subframes, a plurality of downlink transmissions; and
sending an uplink transmission comprising a plurality of bits indicative of whether the downlink transmissions were successfully received.

2. The method of claim 1, wherein the plurality of downlink transmissions are sent from a half-duplex relay node to a user equipment (UE).

3. The method of claim 1, wherein the plurality of downlink transmissions are sent from a donor base station to a half-duplex relay node.

4. The method of claim 3, wherein the donor base station employs a frequency division duplex (FDD) system.

5. The method of claim 3, wherein the plurality of bits is determined based, at least in part, on a set of downlink subframes and a set of uplink subframes configured between the donor base station and the relay node.

6. The method of claim 5, where the plurality of bits is further determined based on a downlink Hybrid Automatic Retransmission reQuest (H-ARQ) timing.

7. The method of claim 5, where the set of downlink subframes and uplink subframes have a periodicity of 8 ms and are configured on a semi-static basis.

8. The method of claim 3, wherein the downlink transmissions comprise at least one of data or control information to be relayed to at least a user equipment (UE).

9. The method of claim 1, wherein the plurality of bits comprises N bits that form a code indicative of possible combinations of downlink transmission successfully and unsuccessfully received.

10. The method of claim 9, wherein the N bits are sufficient to indicative of possible combinations of downlink transmission successfully and unsuccessfully received over four or more subframes, wherein each downlink transmission comprises at least two codewords.

11. The method of claim 1, wherein the plurality of bits are sent in a physical uplink control channel (PUCCH) message.

12. The method of claim 11, wherein the PUCCH message also comprises channel status information.

13. The method of claim 9, wherein the downlink transmissions are received over a plurality of carriers.

14. The method of claim 13, wherein:
the N bits acknowledge bundles of downlink transmissions received over the plurality of carriers in a common subframe.

15. An apparatus for wireless communication by a half-duplex node, comprising:
means for receiving, in a plurality of subframes, a plurality of downlink transmissions; and
means for sending an uplink transmission comprising a plurality of bits indicative of whether the downlink transmissions were successfully received.

16. The apparatus of claim 15, wherein the plurality of downlink transmissions are sent from a half-duplex relay node to a user equipment (UE).

17. The apparatus of claim 15, wherein the plurality of downlink transmissions are sent from a donor base station to a half-duplex relay node.

18. The apparatus of claim 17, wherein the donor base station employs a frequency division duplex (FDD) system.

19. The apparatus of claim 17, wherein the plurality of bits is determined based, at least in part, on a set of downlink subframes and a set of uplink subframes configured between the donor base station and the relay node.

20. The apparatus of claim 19, where the plurality of bits is further determined based on a downlink Hybrid Automatic Retransmission reQuest (H-ARQ) timing.

21. The apparatus of claim 19, where the set of downlink subframes and uplink subframes have a periodicity of 8 ms and are configured on a semi-static basis.

22. The apparatus of claim 17, wherein the downlink transmissions comprise at least one of data or control information to be relayed to at least a user equipment (UE).

23. The apparatus of claim 15, wherein the plurality of bits comprises N bits that form a code indicative of possible combinations of downlink transmission successfully and unsuccessfully received.

24. The apparatus of claim 23, wherein the N bits are sufficient to indicative of possible combinations of downlink transmission successfully and unsuccessfully received over four or more subframes, wherein each downlink transmission comprises at least two codewords.

25. The apparatus of claim 15, wherein the plurality of bits are sent in a physical uplink control channel (PUCCH) message.

26. The apparatus of claim 25, wherein the PUCCH message also comprises channel status information.

27. The apparatus of claim 23, wherein the downlink transmissions are received over a plurality of carriers.

28. The apparatus of claim 27, wherein:
the N bits acknowledge bundles of downlink transmissions received over the plurality of carriers in a common subframe.

29. An apparatus for wireless communication by a half-duplex node, comprising:
at least one processor configured to:
receive, in a plurality of subframes, a plurality of downlink transmissions; and
send an uplink transmission comprising a plurality of bits indicative of whether the downlink transmissions were successfully received; and
a memory coupled with the at least one processor.

30. A computer-program product for wireless communication by a half-duplex node, comprising:
a computer-readable medium comprising code for:
receiving, in a plurality of subframes, a plurality of downlink transmissions; and
sending an uplink transmission comprising a plurality of bits indicative of whether the downlink transmissions were successfully received.

31. A method for wireless communication with a half-duplex node, comprising:
transmitting, in a plurality of subframes, a plurality of downlink transmissions to the half-duplex node; and
receiving, from the half-duplex node, an uplink transmission comprising a plurality of bits indicative of whether the downlink transmissions were successfully received.

32. The method of claim 31, wherein the uplink transmission is received from a user equipment by a half-duplex relay node.

33. The method of claim 31, wherein the uplink transmission is received from a half-duplex relay node by a donor base station.

34. The method of claim 33, wherein the donor base station employs a frequency division duplex (FDD) system.

35. The method of claim 33, wherein the plurality of bits is determined based, at least in part, on a set of downlink subframes and a set of uplink subframes configured between the donor base station and the relay node.

36. The method of claim 35, where the plurality of bits is further determined based on a downlink Hybrid Automatic Retransmission reQuest (H-ARQ) timing.

37. The method of claim 35, where the set of downlink subframes and uplink subframes have a periodicity of 8 ms and are configured on a semi-static basis.

38. The method of claim 33, wherein the downlink transmissions comprise at least one of data or control information to be relayed to a user equipment (UE).

39. The method of claim 31, wherein the plurality of bits comprises N bits that form a code indicative of possible combinations of downlink transmission successfully and unsuccessfully received.

40. The method of claim 39, wherein the N bits are sufficient to indicative of possible combinations of downlink transmission successfully and unsuccessfully received over four or more subframes, wherein each downlink transmission comprises at least two codewords.

41. The method of claim 31, wherein the plurality of bits are sent in a physical uplink control channel (PUCCH) message.

42. The method of claim 31, wherein the PUCCH message also comprises channel information.

43. The method of claim 39, wherein the downlink transmissions are received over a plurality of carriers.

44. The method of claim 43, wherein:
the N bits acknowledge bundles of downlink transmissions received over the plurality of carriers in a common subframe.

45. An apparatus for wireless communication with a half-duplex node, comprising:
means for transmitting, in a plurality of subframes, a plurality of downlink transmissions to the half-duplex node; and
means for receiving, from the half-duplex node, an uplink transmission comprising a plurality of bits indicative of whether the downlink transmissions were successfully received.

46. The apparatus of claim 45, wherein the uplink transmission is received from a user equipment by a half-duplex relay node.

47. The apparatus of claim 45, wherein the uplink transmission is received from a half-duplex relay node by a donor base station.

48. The apparatus of claim 47, wherein the donor base station employs a frequency division duplex (FDD) system.

49. The apparatus of claim 47, wherein the plurality of bits is determined based, at least in part, on a set of downlink subframes and a set of uplink subframes configured between the donor base station and the relay node.

50. The apparatus of claim 49, where the plurality of bits is further determined based on a downlink Hybrid Automatic Retransmission reQuest (H-ARQ) timing.

51. The apparatus of claim 49, where the set of downlink subframes and uplink subframes have a periodicity of 8 ms and are configured on a semi-static basis.

52. The apparatus of claim 47, wherein the downlink transmissions comprise at least one of data or control information to be relayed to a user equipment (UE).

53. The apparatus of claim 45, wherein the plurality of bits comprises N bits that form a code indicative of possible combinations of downlink transmission successfully and unsuccessfully received.

54. The apparatus of claim 53, wherein the N bits are sufficient to indicative of possible combinations of downlink transmission successfully and unsuccessfully received over four or more subframes, wherein each downlink transmission comprises at least two codewords.

55. The apparatus of claim 45, wherein the plurality of bits are sent in a physical uplink control channel (PUCCH) message.

56. The apparatus of claim 45, wherein the PUCCH message also comprises channel information.

57. The apparatus of claim 53, wherein the downlink transmissions are received over a plurality of carriers.

58. The apparatus of claim 57, wherein:
the N bits acknowledge bundles of downlink transmissions received over the plurality of carriers in a common subframe.

59. An apparatus for wireless communication with a half-duplex node, comprising:
at least one processor configured to:
transmit, in a plurality of subframes, a plurality of downlink transmissions to the half-duplex node; and
receive, from the half-duplex node, an uplink transmission comprising a plurality of bits indicative of whether the downlink transmissions were successfully received; and
a memory coupled with the at least one processor.

60. A computer-program product for wireless communication with a half-duplex node, comprising:
a computer-readable medium comprising code for:
transmitting, in a plurality of subframes, a plurality of downlink transmissions to the half-duplex node; and
receiving, from the half-duplex node, an uplink transmission comprising
a plurality of bits indicative of whether the downlink transmissions were successfully received.
